(19) United States
(12) Patent Application Publication
(10) Pub. No.: US 2003/0080731 A1
(43) Pub. Date: May 1, 2003

(54) Apparatus with integral locking pin and cavity seal

(76) Inventors: Thomas Babington, North Dartmouth, MA (US); Norman Poirier, Raynham, MA (US)

Correspondence Address: Grossman, Tucker, Perreault & Pfleger, PLLC, 55 South Commercial Street, Manchester, NH, 03101, US

(21) Appl. No.: 10/268,624

(22) Filed: Oct. 10, 2002

Related U.S. Application Data
(60) Provisional application No. 60/328,166, filed on Oct. 10, 2001.

(51) Int. Cl. G01B 7/14

(52) U.S. Cl. 324/207.2; 324/262

(57) ABSTRACT

A seat position sensor for a vehicle including: a sensing portion configured to sense a position of a vehicle seat with respect to a part of the vehicle; and a mounting portion coupled to the sensing portion, wherein the mounting portion includes an integral locking pin configured to secure the seat position sensor to a portion of the vehicle. A seat position sensor including a housing having an internal surface defining an opening and a seal disposed in the opening to create a cavity for housing electrical circuitry is also provided. A seat position sensor circuit is also provided to enable testing of a varistor without adversely affecting other portions of the circuit.

### CROSS REFERENCE TO RELATED APPLICATIONS

This application claims the benefit of the filing date of U.S. Provisional Application Ser. No. 60/328,166, filed Oct. 10, 2001, the teachings of which are incorporated herein by reference.

### FIELD OF THE INVENTION

The present invention relates generally to an apparatus with an integral locking pin and cavity seal. In particular, such apparatus may be a position sensor utilized in vehicle applications. A position sensor circuit is also provided.

### BACKGROUND OF THE INVENTION

Many vehicles are equipped with sensors for sensing the position of various objects. One such sensor may be a seat track position sensor to sense the position of a vehicle seat. The position of the vehicle seat may be utilized in a variety of other internal vehicle systems including air bag deployment systems, seat position memory systems, seat occupancy sensing systems, and other such systems.

In an air bag deployment system, the sensor may be configured to sense the position of the seat to a predetermined accuracy. In one system, the sensor may be a U-shaped sensor with a magnet in one leg of the U-shaped sensor and a magnetic sensor, e.g., a Hall sensor, in the other leg. The U-shaped open cavity of the sensor may be configured to accept a flange. The flange may interrupt the magnetic field such that the Hall sensor senses different magnetic field conditions depending on the position and shape of the flange. A control signal indicative of the various sensed magnetic field conditions may then be input to an air bag deployment controller.

In this way, the air bag deployment force may be controlled depending on the position of the seat. For example, if the seat is in a forward position closer to the front dashboard or steering wheel, the controller may provide instructions to deploy the air bag with less force. In contrast, if the seat is sufficiently far from the front dashboard or steering wheel, the controller may provide instructions to deploy the air bag with maximum force.

Seat track position sensors are packaged and provided in a variety of ways. Typically, a separate locking pin or fastener is needed in order to lock the sensor in place after the sensor is installed on a mounting bracket. This requires the installer to locate this separate component, which may be unavailable, damaged, or otherwise the incorrect component.

In addition, seat track position sensors typically also require a separate potted printed circuit board (PCB) assembly. This requires a potting operation to seal this separate potted PCB assembly. This separate potted PCB assembly and potting operation requires expensive assembly and process operations, and may not provide a sufficient seal for the PCB.

In addition, a seat track position sensor may include a seat track position sensor circuit having a variety of electrical components including a varistor and a Hall switch. The varistor, as known in the art, protects the circuit against high voltage power surges above the rated breakdown voltage level for the varistor. Typically, the breakdown voltage for the varistor was much lower than the breakdown voltage for the Hall switch. However, as voltage input requirements have increased, the breakdown voltage of the varistor has necessarily increased and may now overlap with the breakdown voltage of the Hall switch. As such, post production testing of such a circuit may give false indications of the functionality of the varistor given the Hall switch could inadvertently turn on first when testing for breakdown of the varistor.

Accordingly, there is a need in the art for an apparatus with an integral locking pin and improved cavity seal, which can be used in a variety of applications including a vehicle seat position sensor. There is also a need for a seat position sensor circuit permitting proper post production testing of a varistor when the varistor's breakdown voltage may overlap that of an associated Hall switch.

### BRIEF SUMMARY OF THE INVENTION

A seat position sensor for a vehicle consistent with the invention includes: a sensing portion configured to sense a position of a vehicle seat with respect to a part of the vehicle; and a mounting portion coupled to the sensing portion, wherein the mounting portion includes an integral locking pin configured to secure the seat position sensor to a portion of the vehicle.

According to another aspect of the invention, there is provided an apparatus including: an integral locking pin having a head portion and a leg portion; and a mounting portion for mounting the apparatus to a mounting location with the integral locking pin, the mounting portion including a member having a first surface and a second surface orthogonal to the first surface, wherein the first surface and the second surface define a first portion of a cavity configured to accept the head portion of the integral locking pin when the integral locking pin is fully inserted into the cavity, and wherein the mounting portion further includes a tapered surface defining a second portion of the cavity configured to accept the leg portion of the integral locking pin when the locking pin is fully inserted into the cavity.

According to a further aspect of the invention, there is provided a seat position sensor for sensing the position of a vehicle seat relative to a portion of a vehicle including: a sensor portion configured to sense the position of the vehicle seat and provide a seat position control signal; a housing having an internal surface defining an opening; a seal disposed in the opening to create a cavity defined by a portion of the internal surface of the housing and an internal surface of the seal; and electrical circuitry disposed in the cavity and configured to accept the seat position control signal.

According to yet another aspect of the invention, there is provided a seat position sensor circuit including: a pair of input/output terminals; a varistor coupled to the terminals; an energy storage element coupled in parallel with the varistor; a forward biased diode having an input terminal and an output terminal, the input terminal coupled to the varistor and the output terminal coupled to the energy storage element; wherein a negative voltage may be applied at the pair of input/output terminals to test the varistor and wherein the forward biased diode would isolate any other electrical components coupled to the output terminal of the diode.

Another seat position sensor circuit consistent with the invention includes: a varistor coupled to a pair of terminals; and a forward biased diode having an input terminal and an output terminal, the input terminal coupled to the varistor and the output terminal coupled to a Hall switch, wherein a negative voltage may be applied at the pair of terminals to test the varistor and wherein the forward biased diode would isolate the Hall switch from the negative voltage.

A method of testing a varistor of a seat track position sensor circuit consistent with the invention includes the steps of: applying a negative voltage to test a break down voltage of the varistor; and blocking the negative voltage to effectively isolate other components of the circuit.

A method of securing a seat position sensor to a vehicle consistent with the invention includes the steps of: locating the sensor in proximity to a mounting portion of the vehicle, the mounting portion having an opening; and forcing an integral locking pin of the sensor into the opening of the mounting portion.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a simplified plan view of a vehicle having a seat track position sensor;

FIG. 2 is a side sectional view of an apparatus including an integral locking pin consistent with the present invention;

FIG. 3 is a cross sectional view along the line 3-3 of FIG. 2 illustrating details of an integral locking pin consistent with the present invention;

FIG. 4 is a cross sectional view illustrating an exemplary cavity and seal for electronic circuitry consistent with the present invention; and

FIG. 5 is a circuit diagram of an exemplary seat track position sensor circuit consistent with the invention.

### DETAILED DESCRIPTION

The present invention relates generally to an apparatus having an integral locking pin and improved cavity seal. A seat position sensor circuit is also provided. The present invention is described with reference to a seat track position sensor to provide seat position information to a variety of internal vehicle systems. Those skilled in the art, however, will recognize that an apparatus consistent with the present invention may be utilized in a host of other environments. Thus, it is to be understood that the present invention is not limited to the illustrated exemplary embodiments described herein. Rather, the present invention may be incorporated in a wide variety of devices without departing from the spirit and scope of the present invention.

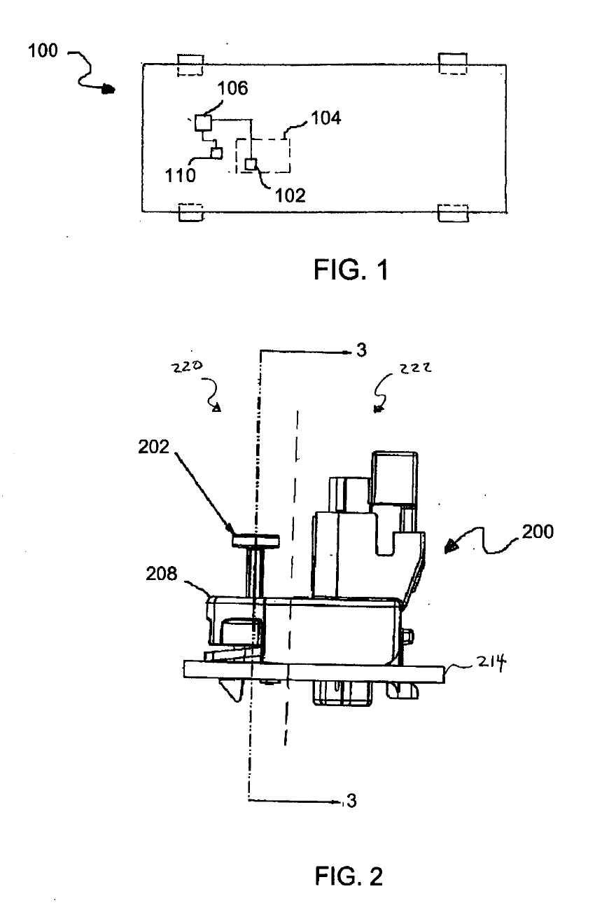

Turning to FIG. 1, a simplified plan view of an exemplary vehicle 100 having a seat track position sensor 102 is illustrated. The seat track position sensor 102 provides position information for the seat 104. In one exemplary embodiment, the seat track position sensor 102 may provide seat position control signals to a controller 106. The controller 106 may then be responsive to such control signals to control the deployment force of an associated air bag 110. For example, if the seat is in a forward position closer to the front dashboard or steering wheel, the controller 106 may provide instructions to deploy the air bag 110 with less force. In contrast, if the seat is sufficiently far from the front dashboard or steering wheel, the controller 106 may provide instructions to deploy the air bag 110 with maximum force.

In other embodiments, the seat track position sensor 102 may provide position information for use in seat position memory systems. In such instances, a seat position may be saved in memory, and a user may activate the seat to move to the saved seat position.

In yet another embodiment, a seat track position sensor 102 may be configured to sense the presence of a person in a construction vehicle seat. When a person occupies the seat, the weight of the person may force a shunt into an open cavity of a sensor having a magnet in one side of the cavity and a Hall sensor in the other side. The sensor then, in turn, may provide a control signal to a separate external controller indicating normal operation of the construction equipment may begin. If, however, the person is then accidentally removed from the seat, the shunt may leave the open cavity and a separate control signal would be indicated. An external controller may use this separate control signal to shut down the running engine of the construction equipment ensuring higher safety.

Turning to FIG. 2, a side sectional view of an apparatus 200 including an integral locking pin 202 consistent with the present invention is illustrated. The apparatus 200 may be a seat track position sensor in one embodiment having a mounting portion 220 and sensing portion 222. The mounting portion advantageously includes the locking pin 202 integral with the sensor such that the installer does not need a separate locking pin that may be unavailable, damaged, or otherwise the incorrect pin. An installer simply needs to apply a downward force to the integral locking pin 202 to push the locking pin though a receptive opening in a mounting plate 214 of a vehicle.

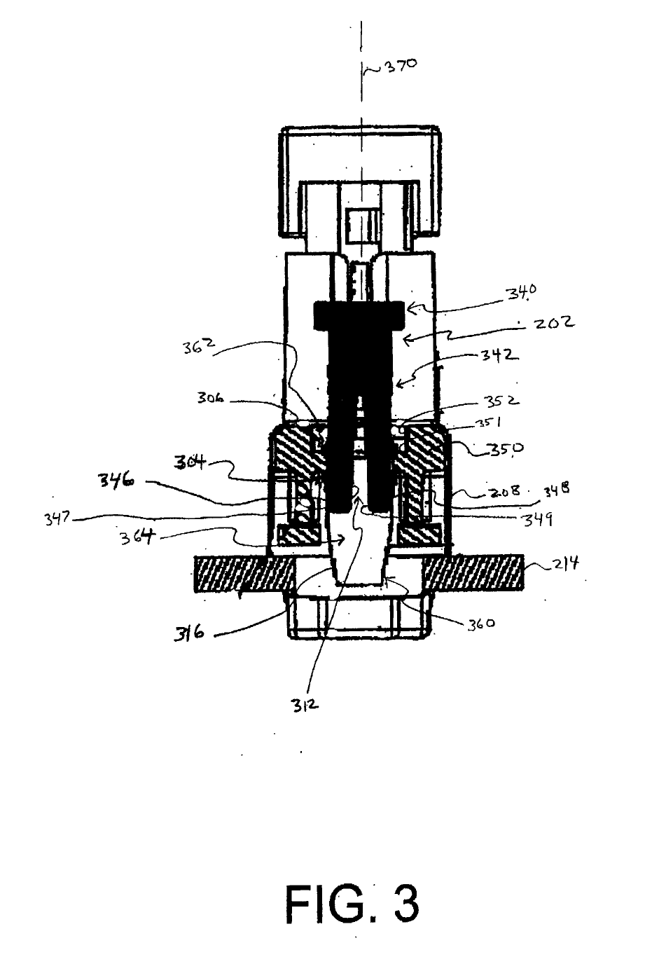

Turning to FIG. 3, a cross sectional view of the apparatus 200 taken along the line 3-3 is illustrated. The integral locking pin 202 is illustrated in a first integral position in which the pin 202 is ready for mounting. In general, the integral locking pin 202 has a head portion 340 and a leg portion 342. The leg portion 342 may further include a first leg 346 and a second leg 348 which have interior surfaces 347, 349 that define a slot 312. The slot 312 may also be defined by an interior surface of a leg portion 342 of the integral locking pin 202 where the leg portion has a hollow cylindrical type shape. The locking pin 202 may further include a first radial protrusion 304 and a second radial protrusion 306 extending radially from a centerline axis 370 of the integral locking pin 202.

The mounting portion of the sensor further includes components that define a cavity 360 to work in cooperation with the above identified features of the integral locking pin 202. The cavity 360 may have a first portion 362 and a second portion 364. A member 350 of the sensor may have a surface 351 and a surface 352 which is orthogonal to surface 351 that together define the first portion 362 of the cavity 360. This first portion 362 of the cavity 360 is sized to receive the head portion 340 of the integral locking pin 202 when the integral locking pin is fully inserted into the cavity 360. A tapered surface 316 of the mounting portion of the sensor defines the second portion 362 of the cavity 360.

In operation, the integral locking pin 202 may by have a variety of positions to simplify mounting. FIG. 3 illustrates the pin 202 in a first integral position in which the pin 202 is prepared to assist with mounting of the sensor to the mounting plate 214. If an outwardly exerted force is applied to the pin, the first radial portion 304 of the pin 202 contacts a surface portion of member 350 and thus prohibits the pin 202 from being extracted from the sensor. As such, the locking pin 202 advantageously remains integral with the sensor until the sensor or apparatus is ready for final assembly in the correct assembly location.

Once the sensor or apparatus is located in a position ready for assembly, e.g., a seat position sensor for mounting to a mounting plate of a vehicle, a downward force is exerted by an installer on the integral locking pin 202. As the pin 202 moves downward, the tapered surface 316 forces the leg portion 342 of the pin 202 closer together thereby narrowing the slot 312 opening. As this occurs, the second radial protrusion 306 is forced or deflected inward allowing it to pass through the opening defined by the member 350 and also allowing the second radial protrusion to pass through the narrow opening defined by the narrow end of the tapered surface 316.

If an outwardly exerted force is applied to the pin once it is fully inserted into the cavity 360, the second radial portion 306 of the pin 202 contacts a surface portion on the exterior of the cavity and thus prohibits the pin 202 from being extracted from the sensor. The slot 312 is outwardly biased sufficiently to maintain the integral locking pin in its fully assembled position. Advantageously, a staged pin assembly consistent with the present invention is thereby incorporated without any additional components. Those skilled in the art will recognize a plurality of radial protrusions may be provided on a locking pin 202 for different applications without departing from the scope of the present invention.

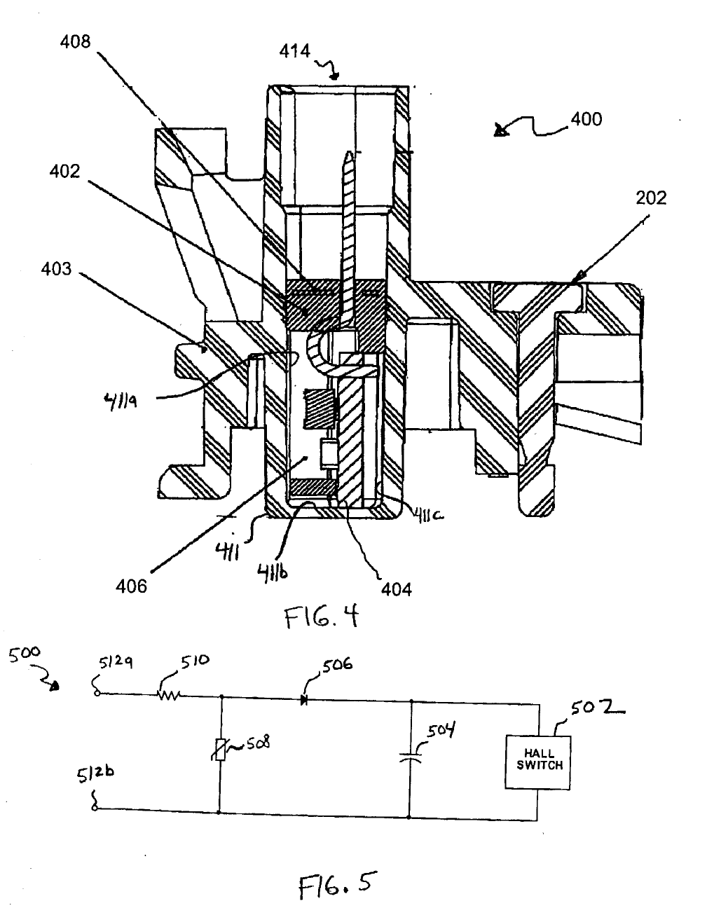

Turning to FIG. 4, another embodiment of the present invention including a seal 402 for protecting internal electrical circuitry, e.g., for protecting a PCB 404, is illustrated. In the exemplary embodiment of FIG. 4, an exemplary seal 402 is formed and positioned to adequately seal a PCB 404 in a PCB cavity 406. The other portions of the cavity 406 are formed by the internal surfaces 411a, 411b, 411c of the housing 411. The cavity seal 402 may be formed by an injection-molded elastomer and may further include a retainer plate 408.

The injection-molded elastomer may be injected into a mold exterior to the apparatus 400. The retainer plate 408 may be stainless steel, which provides a rigid structure to the cavity seal 402. The retainer plate 408 also provides gripping pressure to the seal 402 to assist gripping the seal to the internal housing surfaces 411a, 411c. The seal 402 may include an elastomer type that provides an adequate seal between the seal 402 and the internal housing surfaces 411a, 411c.

For instance, the formed elastomer may be sufficiently flexible so that the seal can be compressed and inserted in the opening 414. When the seal 402 reaches its sealed position as illustrated in FIG. 4, the elastomer attempts to expand against the internal housing surfaces 411a, 411c thus providing a tight seal that prevents leakage of unwanted contaminants into the cavity 406. Additional sealing features are provided for the electrical terminals to prevent leakage along this possible leak path.

Turning to FIG. 5, another embodiment of the present invention including an exemplary seat position sensor circuit 500 is illustrated. The seat position sensor circuit 500 generally includes a Hall switch 502, an energy storage element, e.g., a capacitor 504, a diode 506, a varistor 508, and a resistor 510. Such an exemplary circuit 500 may be located on the PCB 404 of the sensor 400 illustrated in FIG. 4.

The varistor 508, as known in the art, protects the circuit 500 against high voltage power surges. When a voltage surge exceeding a predetermined voltage level or varistor voltage level is applied, the varistor suppresses such voltage by rapidly decreasing its resistance and creating a shunt path for the voltage surge. If such a voltage surge does not exceed the varistor voltage level, the varistor acts as a capacitor.

Once the circuit is constructed, various tests are typically undertaken to test the functionality of various components of the circuit 500, e.g., the varistor 508. Advantageously, the exemplary circuit 500 enables testing of the varistor 508 with a current limited negative voltage which gives a true sense of the varistor functionality without inadvertently turning the Hall switch on. To accomplish this, the varistor 508 is connected in parallel with the input/output terminals 512a, 512b and the forward biased diode 506 is connected in series between the varistor 508 and the capacitor 504. As such, this circuit 500 enables post circuit production testing to apply a current limited negative voltage to the circuit 500 to verify proper operation of the varistor 508. The forward biased diode 506 prevents such current limited negative voltage from inadvertently turning on the Hall switch 502. As is known in the art, checking the breakdown voltage with negative or positive voltage is a legitimate check of the functionality of a varistor, since varistors are inherently bilateral devices.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

What is claimed is:

1. A seat position sensor for a vehicle, said sensor comprising:
a sensing portion configured to sense a position of a vehicle seat with respect to a part of said vehicle; and
a mounting portion coupled to said sensing portion, wherein said mounting portion comprises an integral locking pin configured to secure said seat position sensor to a portion of said vehicle.

2. The sensor of claim 1, wherein said mounting portion comprises a tapered surface defining a cavity, and wherein a portion of said integral locking pin is disposed in said cavity.

3. The sensor of claim 2, wherein said integral locking pin has opposing interior surfaces defining a slot.

4. The sensor of claim 2, wherein said integral locking pin has a first leg having a first interior surface and a second leg having a second interior surface, wherein said first interior surface and said second interior surface define a slot.

5. The sensor of claim 2, wherein said integral locking pin has a head portion and a leg portion, said leg portion having first leg with a first interior surface and a second leg with a second interior surface, wherein said first interior surface and said second interior surface define a slot.

6. The sensor of claim 2, wherein said integral locking pin has a first radial protrusion and a second radial protrusion, wherein said integral locking pin has a first position in preparation for installation where said first radial protrusion cooperates with a member of said mounting portion for securing a first portion of said integral locking pin in said cavity.

7. The sensor of claim 6, wherein said integral locking pin has a second position wherein said integral locking pin has been fully inserted into said cavity and wherein said second radial protrusion cooperates with an end portion of said cavity for securing said locking pin in said cavity.

8. An apparatus comprising:
an integral locking pin having a head portion and a leg portion; and
a mounting portion for mounting said apparatus to a mounting location with said integral locking pin, said mounting portion comprising a member having a first surface and a second surface orthogonal to said first surface, wherein said first surface and said second surface define a first portion of a cavity configured to accept said head portion of said integral locking pin when said integral locking pin is fully inserted into said cavity, and wherein said mounting portion further comprises a tapered surface defining a second portion of said cavity configured to accept said leg portion of said integral locking pin when said locking pin is fully inserted into said cavity.

9. The apparatus of claim 8, wherein said integral locking pin has a first leg having a first interior surface and a second leg having a second interior surface, wherein said first interior surface and said second interior surface define a slot.

10. The apparatus of claim 8, wherein said integral locking pin has a first radial protrusion and a second radial protrusion, wherein said integral locking pin has a first position in preparation for mounting where said first radial protrusion cooperates with a portion of said member for securing a first portion of said integral locking pin in said cavity.

11. The apparatus of claim 10, wherein said integral locking pin has a second position wherein said integral locking pin has been fully inserted into said cavity and said first portion of said cavity accepts said head portion and said second portion of said cavity accepts said leg portion, and wherein said second radial protrusion cooperates with an end portion of said second portion of said cavity for securing said locking pin in said cavity.

12. A seat position sensor for sensing the position of a vehicle seat relative to a portion of said vehicle, said sensor comprising:
a sensor portion configured to sense said position of said vehicle seat and provide a seat position control signal;
a housing having an internal surface defining an opening;
a seal disposed in said opening to create a cavity defined by a portion of said internal surface of said housing and an internal surface of said seal; and
electrical circuitry disposed in said cavity and configured to accept said seat position control signal.

13. The sensor of claim 12, wherein said seal comprises an injection molded elastomer.

14. The sensor of claim 13, wherein said seal further comprises a retainer plate.

15. The sensor of claim 12, wherein said electrical circuitry comprises a printed circuit board (PCB).

16. A seat position sensor circuit comprising:
a pair of input/output terminals;
a varistor coupled to said terminals;
an energy storage element coupled in parallel with said varistor;
a forward biased diode having an input terminal and an output terminal, said input terminal coupled to said varistor and said output terminal coupled to said energy storage element, wherein a negative voltage may be applied at said pair of input/output terminals to test said varistor and wherein said forward biased diode would isolate any other electrical components coupled to the output terminal of said diode.

17. The circuit of claim 16, wherein one of said components is a Hall switch.

18. The circuit of claim 16, wherein a break down voltage level of said Hall switch is less than a break down voltage level of said varistor.

19. A seat position sensor circuit comprising:
a varistor coupled to a pair of terminals; and
a forward biased diode having an input terminal and an output terminal, said input terminal coupled to said varistor and said output terminal coupled to a Hall switch, wherein a negative voltage may be applied at said pair of terminals to test said varistor and wherein said forward biased diode would isolate said Hall switch from said negative voltage.

20. A method of testing a varistor of a seat track position sensor circuit comprising the steps of:
applying a negative voltage to test a break down voltage of said varistor; and
blocking said negative voltage to effectively isolate other components of said circuit.

21. The method of claim 20, wherein one of said components is a Hall switch.

22. The method of claim 20, wherein said blocking step is provided by a forward biased diode.

23. A method of securing a seat position sensor to a vehicle comprising the steps of:
locating said sensor in proximity to a mounting portion of said vehicle, said mounting portion having an opening; and
forcing an integral locking pin of said sensor into said opening of said mounting portion.

24. The method of claim 23, wherein said integral locking pin is in a first integral position during said locating step, and wherein said forcing step forces said locking pin into a second integral position.
